(19) United States
(12) Patent Application Publication
(10) Pub. No.: US 2018/0276432 A1
(43) Pub. Date: Sep. 27, 2018

(54) SYSTEM, METHOD AND APPARATUS FOR ENCODING, VERIFYING, AND PRINTING OF RFID ENABLED OBJECTS

(71) Applicants: Krishnamoorthy Manickam, Dayton, OH (US); Frederick J Pestian, Dayton, OH (US)

(72) Inventors: Krishnamoorthy Manickam, Dayton, OH (US); Frederick J Pestian, Dayton, OH (US)

(21) Appl. No.: 15/936,337

(22) Filed: Mar. 26, 2018

Related U.S. Application Data
(60) Provisional application No. 62/476,008, filed on Mar. 24, 2017.

(51) Int. Cl. G06K 7/10; G06K 1/12; G06K 19/07

(52) U.S. Cl. CPC G06K 7/10366; G06K 19/0723; G06K 1/121

(57) ABSTRACT

A method, system and apparatus for encoding, printing and verifying RFID objects on a moving transport system. The system can run non-stop as a plurality of batches are added while system is producing an active job. The system can include multiple transporting mechanisms, indicia scanner, at least one tracking sensor, RFID antenna for continuous reading of the unique tag information such as the EPC, at least one RFID antenna for encoding, printing mechanism to print, RFID antenna for final verification, second indicia scanner for final verification, marking and divert mechanisms for objects containing failed or weak RFID inlays, sensor to ensure said RFID object is removed from the transport mechanism and processor in communication with and adapted to control the operation of all devices. The system will encode said tags using well established encoding techniques supplemented by specialized RF Focusing Antenna Enclosures and new continuous-read tag singulation encoding procedures.

### CROSS-REFERENCE TO RELATED APPLICATIONS

The present Utility patent application claims priority benefit of the [U.S. provisional application for patent Ser. No. 62/476,008, entitled “System, Method and Apparatus for Encoding, Verifying, and Printing of RFID Enabled Objects”, and filed on Mar. 24, 2017 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to Radio Frequency Identification (RFID). More particularly, certain embodiments of the invention relate to a system, method and apparatus for encoding, verifying, and printing RFID enabled objects.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. RFID inlays are typically incorporated into labels or cardstock to form tags that can be applied to items or item packaging either directly through the use of adhesive or indirectly such as through a fastener, e.g. string, plastic tie, etc. Labels and tags incorporating RFID inlays can complement the advantages of RFID with visual indicia, such as barcodes, alphanumeric identifiers, descriptive text, variable and fixed, and pictographic information. For example, in a retail environment, an apparel hang tag can incorporate an RFID inlay and can further include graphic information such as the brand of the product, fixed indicia such as product description, variable indicia such as product size, price, care, product identifying information such as a barcode, and so forth. Due to the high rate of adoption by the apparel retail sector of Ultra High Frequency (UHF) RFID tagging at the item level, all areas of RFID tag manufacturing and encoding are working to increase their production capabilities. While RFID chip makers, RFID tag makers and RFID tag converters are rapidly increasing their ability to provide the industry the rapidly increasing quantity of UHF RFID tags to meet the rising demand, very little is being done to increase the rate of encoding and verification of said UHF RFID tags.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that conventional encoding & verification techniques identify (singulate) RFID tags using a sensor to trigger the initial read of each RFID tag prior to said tag being encoded. Unfortunately, this technique limits the speed of the initial singulation process and in turn limits the speed of the complete encoding and verification process. By way of educational background, another aspect of the prior art generally useful to be aware of is that a common means of encoding RFID labels and tags (Product) is to move the RFID product passed one to many RFID antennas that communicate with the RFID product to identify (singulate) the individual RFID item and then to encode the singulated RFID item. This process of singulation becomes more difficult the smaller the RFID product and the closer the plurality of RFID products are to each other. A known method of singulating a RFID product is varying the strength of the RF signal being emitted from the RFID antenna. Then, if there is still more than one RFID product identified by the RFID system, the RFID product showing the strongest response will be determined to be the product that is closest to the antenna, or the singulated product. Another known method is using the magnetic coupling model where they start and stop the RF signal.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an exemplary embodiment of a system for encoding, printing, and verifying RFID inlays;

FIG. 2 shows an exemplary embodiment of an apparatus for encoding, printing, and verifying RFID inlays on roll to roll, roll to cut singles, or cut singles only;

FIG. 3 shows an exemplary embodiment of a method for encoding, printing, and verifying RFID inlays;

FIG. 4 provides an exemplary schematic of the RF focusing antenna enclosure system used to contain and direct RF signals for continuous RF transponder singulation;

FIGS. A through I are process flow diagrams;

FIG. 5 provides an exemplary schematic of the RF focusing antenna enclosure system used to contain and direct RF signals for continuous RF transponder singulation;

FIG. 6 shows an exemplary embodiment of a conventional techniques used to singulate RFID tags an unshielded RFID antenna;

FIG. 7 shows an exemplary embodiment of this invention being used to focus the RFID energy to a confined area thus only communicating with one RFID inlay; and

FIG. 8 shows an exemplary embodiment of how the adjustable shielding plate is used to further focus the RFID energy to a smaller area required for smaller RFID product where the inlays are very close together.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One or more embodiments of the present invention may comprise a method, system and apparatus for encoding, printing and verifying RFID objects on a moving transport system. The system can run non-stop as a plurality of batches are added while system is producing an active job. The system can include multiple transporting mechanisms, indicia scanner, at least one tracking sensor, RFID antenna for continuous reading of the unique tag information such as the EPC, at least one RFID antenna for encoding, printing mechanism to print, RFID antenna for final verification, second indicia scanner for final verification, marking and divert mechanisms for objects containing failed or weak RFID inlays, sensor to ensure said RFID object is removed from the transport mechanism and processor in communication with and adapted to control the operation of all devices. The system will encode said tags using well established encoding techniques supplemented by specialized RF Focusing Antenna Enclosures and new continuous-read tag singulation encoding procedures.

RFID inlays are typically incorporated into labels or cardstock to form tags that can be applied to items or item packaging either directly through the use of adhesive or indirectly such as through a fastener, e.g. string, plastic tie, etc. Labels and tags incorporating RFID inlays can complement the advantages of RFID with visual indicia, such as barcodes, alphanumeric identifiers, descriptive text, variable and fixed, and pictographic information. For example, in a retail environment, an apparel hang tag can incorporate an RFID inlay and can further include graphic information such as the brand of the product, fixed indicia such as product description, variable indicia such as product size, price, care, product identifying information such as a barcode, and so forth.

Due to the high rate of adoption by the apparel retail sector of Ultra High Frequency (UHF) RFID tagging at the item level, all areas of RFID tag manufacturing and encoding are working to increase their production capabilities. While RFID chip makers, RFID tag makers and RFID tag converters are rapidly increasing their ability to provide the industry the rapidly increasing quantity of UHF RFID tags to meet the rising demand, very little is being done to increase the rate of encoding and verification of said UHF RFID tags.

Conventional encoding & verification techniques singulate RFID tags using a sensor to trigger the initial read of each RFID tag prior to said tag being encoded. Unfortunately, this technique limits the speed of the initial singulation process and in turn limits the speed of the complete encoding and verification process. Accordingly, there is a need to eliminate the bottleneck created by the triggered singulation read process. A second concern with conventional encoding and verification techniques is that the encoding and verification system resides on the RFID reader making the systems proprietary in nature to the RFID reader they are developed for. This severely limits the ability to move the system from older outdated RFID equipment to new RFID equipment in a rapidly advancing industry. Accordingly, there is a need for a RFID encoding and verification system that is server based and able to work with any RFID reader by simply developing new drivers for new RFID readers as they are developed. A third concern with conventional RFID encoding and verification systems is that they are developed for one type of RFID, UHF or High Frequency (HF). While the apparel industry has adopted UHF RFID as the optimal RFID technology, the medical industry is using both UHF and HF RFID technologies. While UHF RFID technology is ideal for tracking larger medical assets due the read range in the range of 3 meters, smaller medical device tracking benefits more from the short read range of a few centimeters in order to more accurately determine item location in a densely populated environment. Accordingly, there is a need for a RFID encoding and verification system that can operate with both HF and UHF RFID frequencies. A fourth concern with conventional RFID encoding and verification systems is that the RF signal emanating from RFID antenna are not focused and therefore may cross couple, or read inlays in front of or behind the target inlay. Accordingly, there is a need for a RF signal focusing apparatus that will restrict the RF signal to a focused beam. A fifth concern is that current systems do not re-evaluate the indicia to the EPC at the verification step. Accordingly, there is a need to add a final indicia to EPC comparison step to ensure only fully verified RFID objects are delivered to the customer. A sixth concern is that there is not a roll to cut single production system incorporated into one system that will produce roll to roll, cut singles only, and roll to cut single RFID objects. Accordingly, there is a need for a RFID encode, print, and verification system that is able to work with all three aforementioned RFID object production processes.

Exemplary embodiments disclosed herein includes a system that will address all six of the concerns listed above. This invention utilizes new continuous reading singulation techniques to eliminate the limits of using sensing devices to trigger the read cycle, it is computer based so it is not restricted to pre-selected RFID devices, it is able to encode and verify both HF and UHF RFID tags eliminating the requirement to maintain multiple encoding and verification systems, it has a scanner that verifies any printed indicia is readable and correlates with the EPC encoded to the RFID inlay, and finally, it incorporates a RF focusing antenna enclosure to eliminate unintentional tag reads.

According to at least one exemplary embodiment, a system encoding a RFID tag, label or inlay incorporated in or with an object, the object not requiring indicia disposed thereon, is described. The system can include multiple object transporting mechanisms, at least one scanner for scanning indicia when present, at least one RFID antenna for retrieving the unique information such as the EPC of the chip on the RFID inlay for encoding purposes and the TID of the chip for final verification purposes, at least one RFID antenna enclosed in a RF focusing antenna enclosure for encoding the chip on the RFID inlay, at least one RFID antenna for final verification of the encoding of the chip on the RFID inlay, a marking mechanism to mark failed objects, a cutting mechanism to convert roll stock to cut singles, and a processor in communication with and adapted to control the operation of the object transporting mechanisms, the scanner(s), the marking mechanism, the cutting mechanism, and the RFID antennas.

According to another exemplary embodiment an apparatus for encoding a chip as part of a RFID tag, label or inlay incorporated in or associated with an object is described. The apparatus can include various printing platforms for printing fixed and/or variable information and multiple object transporting mechanisms for transporting the object from a first location to a second location, a scanner disposed between the first location and the second location, the scanner triggered by an object sensor to read variable (serial number of EPC) or fixed (SKU or UPC) OCR or Barcode data, present in indicia disposed on the object if said indicia exists, and at least one RFID antenna located within a RF focusing antenna enclosure disposed between the first location and the second location having read capabilities to obtain the unique information of each RFID chip using a continuous read technique, at least one RFID antenna having read and write capabilities for encoding the chip of the RFID inlay based on the encoding data, at least one RFID antenna having read capabilities for verifying that the chip has been correctly encoded, a marking mechanism to mark objects containing failed or weak RFID inlays, a divert mechanism for removing cut single RFID objects containing failed or weak RFID inlays from transport mechanism, a sensor to ensure said RFID object is removed from said transport mechanism.

According to another exemplary embodiment, a method for encoding a chip on a RFID inlay is described. The method can include providing an object incorporating an RFID inlay and possibly having indicia disposed thereon, obtaining encoding data from the indicia if it exists or from a data file if no indicia exists, and encoding the chip on the RFID inlay with the encoding data.

According to at least one exemplary embodiment, a system, method and apparatus for encoding a chip of a RFID inlay is disclosed. The system may be adapted to encode RFID inlays that are incorporated into objects, for example RFID inlays laminated into labels, hang tags, or the like or intermediate assemblies that will become tags, labels or tickets. The RFID objects can have indicia printed thereon, wherein the indicia may include data that is used to retrieve or determine the data to be encoded into the chip on the RFID inlay. The system may be adapted to read the printed indicia, convert the encoding data into a desired format such as EPC, and subsequently encode the RFID inlay with the converted encoding data. The system may also use the data from the indicia as key data used to retrieve the data to be encoded to the RFID inlay from a database located within a computing device. The system may further include verification control and error handling procedures, allowing the system to verify encoded RFID tags and reject the RFID tags that fail the verification test. The indicia may be printed for example by using any number of different printing platforms available. Said printing may occur prior to the encoding process with an external printing mechanism or the said printing may occur with an inline print mechanism 135 incorporated into the encoding system.

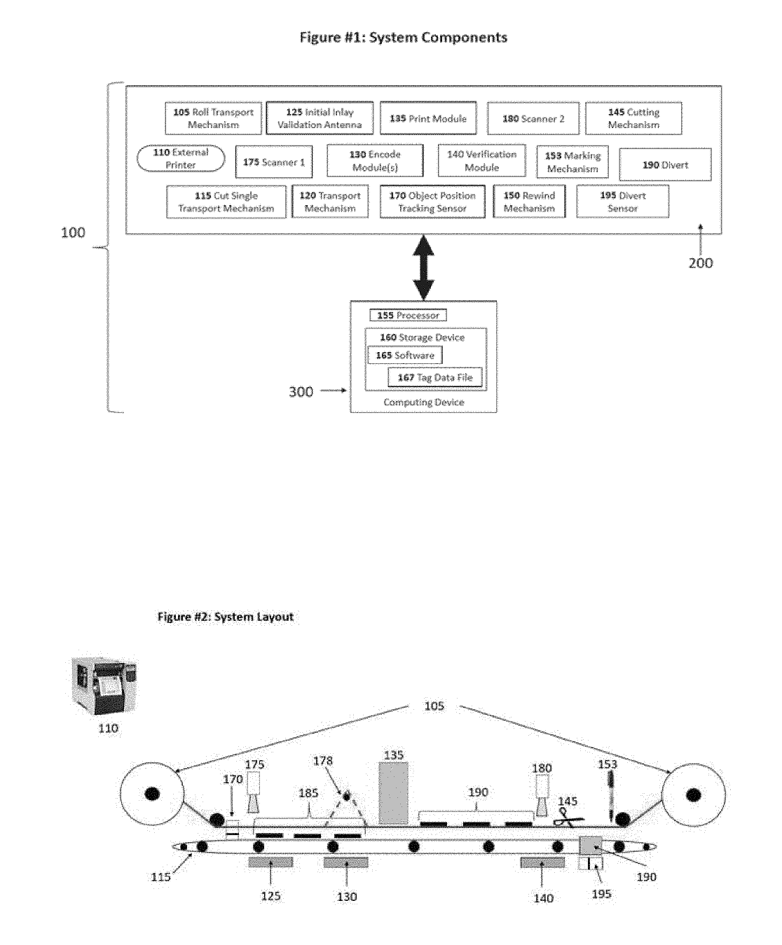

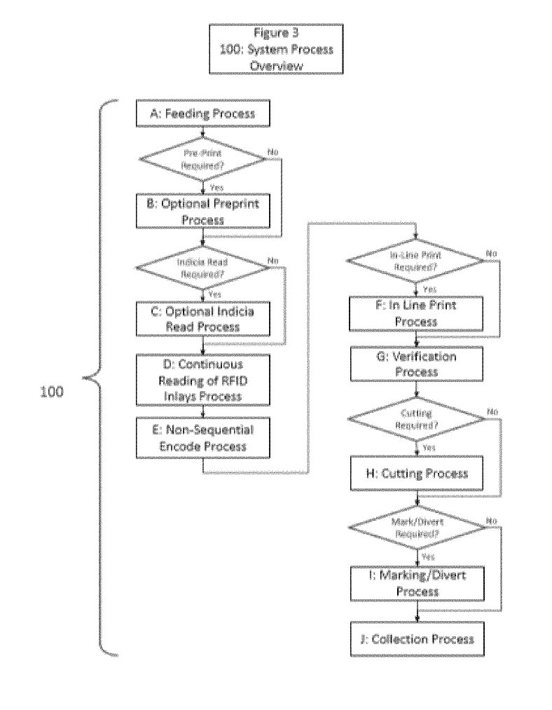

FIG. 1 is a diagram of an exemplary embodiment of a system 100 for encoding, printing, and verification of RFID inlays. When referring to encoding RFID inlays, tags, tickets or labels, this refers to encoding a chip or circuit that is applied to the surface of the inlay to which a RFID antenna is connected. System 100 can include multiple transport mechanisms 105 for roll to roll and 115 for cut singles, an initial indicia scanner 175, a continuous read RFID antenna enclosed in a RF focusing antenna enclosure 125, and at least one RFID encoding antenna 130, an object sensor 170, communicatively and operatively coupled to computing device 300, for detecting the presence of an object on transport mechanism 105 or 115, a printing mechanism 135, an indicia verification scanner 180, a verification RFID antenna 140, a cutting mechanism 145, a marking mechanism 153, a divert mechanism 190 and a divert item sensor 195. Each of the system components may be communicatively and operatively coupled to a computing device 300 running software 165 for managing the RFID encoding process. The computing device 300 can include a processor 155 for executing software 165 and a non-transitory computer readable storage device 160 on which software 165 may be stored. Computing device 300 can further include at least one communications adapter for communicating with system components. The computing device 300 can also be connected to a printing device 110 or 135 so as to coordinate the printing of indicia on the RFID object. Communications between computing device 300 and other system components may be bidirectional.

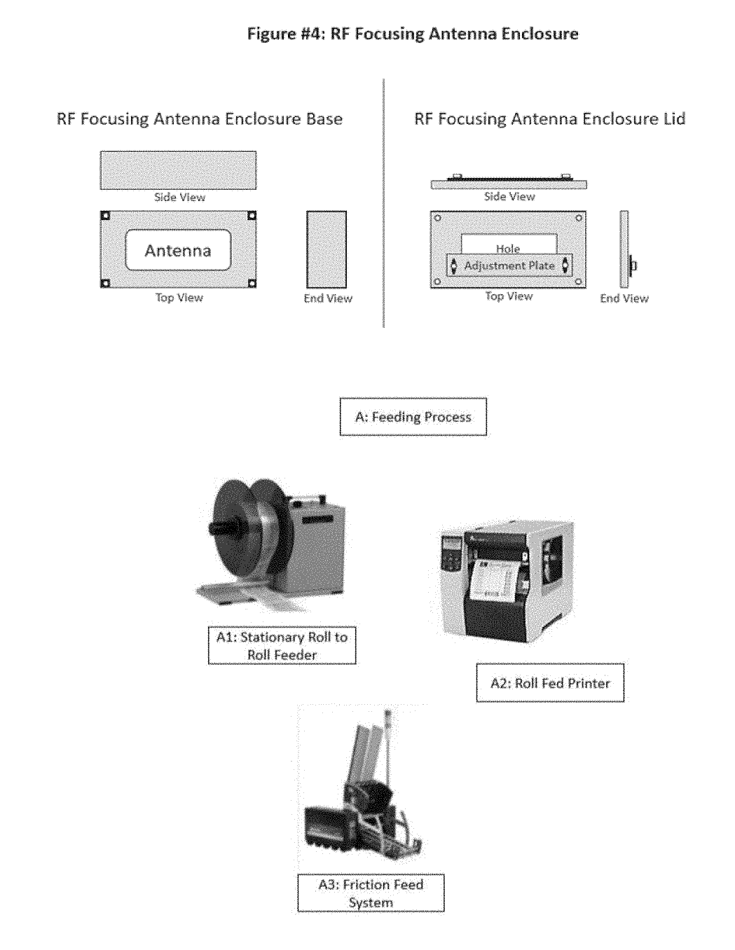

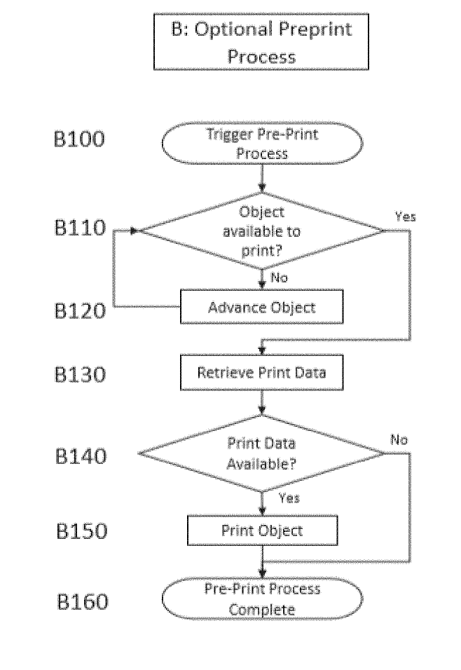

Turning to FIG. 2, an exemplary embodiment of an encoding apparatus 200 is shown. The transport mechanism 105 of the encoding apparatus 200 can serve to transport roll to roll RFID objects 190 while the transport mechanism 115 of the encoding apparatus 200 can serve to transport cut single RFID objects 185 having RFID inlays incorporated therein from a first location to a second location. The transport mechanisms may be any device that allows apparatus 200 and system 100 to function as described herein. It may also be a device that can be connected to an external printing mechanism 110 so as to enable continuous processing of the RFID labels and inlays. In some exemplary embodiments, transport mechanisms 105 and 115 may be adapted to interface with computing device 300 and software 165 such that the operation of transport mechanisms 105 and 115 may be controlled by computing device 300. The communication between transport mechanisms 105 and 115 and computing device 165 may be bidirectional.

The objects 185 and 190 may be any desired object having an RFID inlay therein and may or may not have indicia disposed thereon. Objects 185 and 190 may further be substantially planar objects, having a plurality of laminated layers, with RFID inlays laminated therein. Examples of such objects may be adhesive labels, hang tags, tickets, and so forth. Objects 185 and 190 may further have indicia disposed thereon. The indicia may include barcodes, which may be 1-dimensional or 2-dimensional barcodes, as well as other machine readable or scannable codes as well as alphanumeric information. Included in indicia may be information for encoding the RFID inlays disposed within the 185 and 190 objects. The encoding data may be provided in any suitable format. In some exemplary embodiments, this data may be a hexadecimal representation of the data that is to be programmed into the RFID object.

Scanners 175 and 180 may be any known scanner that is capable of reading 1-dimensional and 2-dimensional barcodes in any format. In some exemplary embodiments, the scanners may also include optical character recognition capabilities so as to allow the scanners to read alphanumeric data.

At least one RFID antenna 130 may be adapted for writing to, reading, and locking RFID inlays. In some exemplary embodiments, the reading, writing and locking functionalities may be provided by a single RFID antenna 130. In other exemplary embodiments, the reading, writing, and locking functionalities may be provided in a plurality of cascading RFID antennas 130.

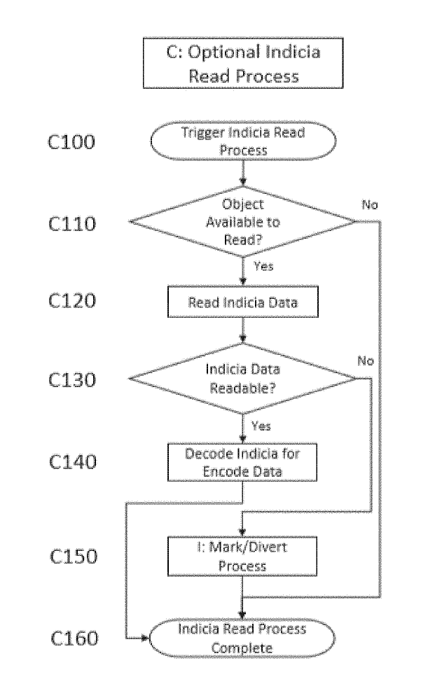

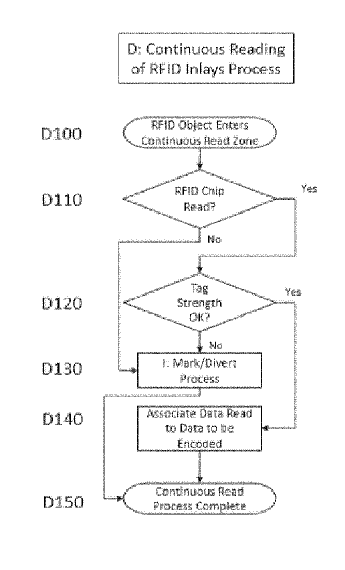

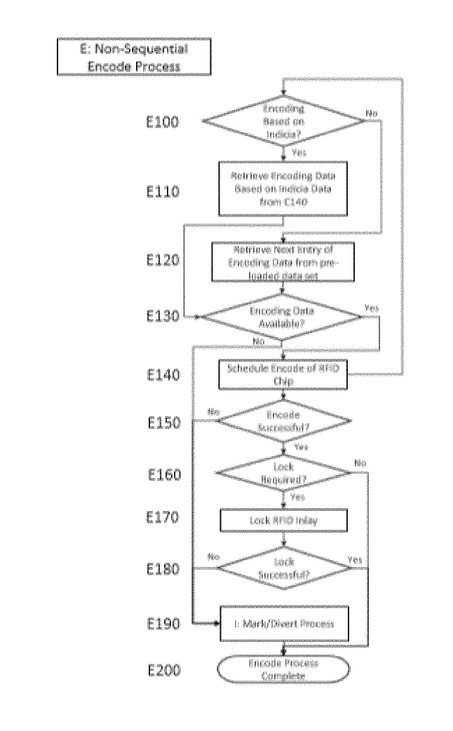

FIG. 3 shows an exemplary diagram of the 10 distinct processes that can be dynamically configured based on the type of base stock, printing methods, and method for encoding an RFID inlay. By configuring selected processes different capabilities of the system 100 are used to encode, print, and or verify a vast array of current RFID objects required by the RFID object industry. Each process will be further discussed for this invention.

The first process is the feed process A where RFID objects are fed into the system 200 for processing. Depending on the type of RFID object being processed, one of three different forms of object feed may be used. For roll to roll or roll to cut single RFID objects, a stationary roll to roll feeder A1 or a roll fed printer A2 is used. For cut single RFID objects, a friction feed system A3 is used.

The second process B pre-printing of the RFID objects with some indicia, is an optional process. For this process, any printer may be used that can print to the RFID object to be transported through system 200. All data to be included in the indicia shall be obtained from a supplied datafile in sequential order.

The third process C indicia reading is also an optional process. Scanner 175 used for this process may be any known scanner that is capable of reading 1-dimensional and 2-dimensional barcodes in any format. In some exemplary embodiments, the scanners may also include optical character recognition capabilities so as to allow the scanners to read alphanumeric data. As the RFID object printed with indicia passes scanner 175 as it is transported from position 1 to position 2 of system 200 the scanner will read the indicia printed on the RFID object. The indicia will be parsed to obtain a pre-configured key field. Data from that key field will be stored for use in the encoding process E. If indicia is expected and no indicia is detected or the expected indicia is not readable, the RFID object will be flagged for rejection.

The fourth process D Continuous Reading of RFID Inlays is the process where unique tag identification such as the factory encoded EPC is captured to be used by the encoding process E. The antenna 125 for this process is housed inside of a special RF focusing antenna enclosure. This special enclosure focuses the RF signal to eliminate cross reads of RFID inlays. Said enclosure includes an adjustable plate to further focus the RF signal for smaller RFID objects. As the RFID object is transported from location 1 to location 2 of system 200, it passes over the RF focusing enclosure 125 and the unique tag identification such as the factory encoded EPC for that RFID inlay is captured. One optional step in this process is to compare the RSSI from the RFID inlay to a pre-configured setting. If the tag EPC is not read or the RSSI for an inlay does not meet the strength set in the configuration settings, the RFID object will be flagged for rejection, otherwise the tag EPC will be recorded for use by the encoding process E.

At process E, the RFID inlay is to be encoded by RFID encoding apparatus 130 with the encoding data obtained at step E120. If there is a plurality of RFID encoding apparatuses, then the RFID transponder will be re-energized by each RFID encoding apparatus. Each downstream RFID encoding apparatus singulates the RFID transponder based on the EPC value encoded by the upstream RFID encoding apparatus. For large pitch roll to roll labels, an optional extended V web path 178 may be utilized to increase the time a RFID transponder is in the RF field.

The RFID inlay may then be read so as to verify the encoding, at step E140. If the encoding is not successful, apparatus 200 may communicate with computing device 300 and send an error status to software 165. Subsequently, apparatus 200 can flag the RFID object for rejection. In some exemplary embodiments, system 100 may be adapted to include a plurality of cascading encoding apparatuses 130. Each encoding apparatus 130 may be communicatively coupled to computing device 300. Each encoding apparatus 130 may include a distinct identifier, allowing the plurality of cascading encoding apparatuses 130 to be controlled from a single computing device 300. In the case of cascading encoders, downstream encoders will handle fail over from upstream encoders. If the encoding step is successful, the RFID inlay may then be locked, at step E170. The last of the cascading encoders will perform the inlay lock process if so configured to provide increased encoding throughput. Upon locking, at step E170, apparatus 200 may communicate with computing device 300 and send a success status to software 165, notifying the software that the RFID inlay was successfully encoded and locked. The success status message can further include the ID of the RFID inlay that was successfully encoded, which can be recorded by software 165.

The sixth process F in-line printing is an optional process. When the system 100 is configured for in-line printing, software 165 uses data retrieved for the encoding process to print to the RFID object. If the encoding process is successful for a RFID object, then the object will be printed. If the encoding process was unsuccessful then no printing will occur.

The seventh process G verification process performs several different verification steps depending on how the system 100 is configured. If indicia are present on the RFID object it will be read by the verification scanner 180 to ensure it is readable. If the indicia is readable, the contents of the indicia will be stored in memory on the computing device 300. In all cases the EPC encoded to the RFID inlay will be read by the verification module 140. If any passwords have been encoded to the RFID inlay they will be verified as well. If the indicia is not readable or does not match the EPC encoded, or any passwords encoded are not correct, the RFID object will be flagged for rejection and print & encode data for that object will be added to the reprint queue in system software 165.

The eighth process H cutting, is only used when processing roll to cut single RFID objects. A rotary cutter, mechanical die cutter, laser cutter or the like may be included between the verification process 140 and marking/divert process Ito cut the roll fed substrate into individual RFID tags, tickets and inlays.

For RFID objects that fail any of the above steps, for example scanning step D110 or encoding step E140, an error status may be sent to software 165. The error status can contain any desired information, for example an exception message and an identification of the step that the particular RFID object failed to pass. This data may further be recorded by software 165. The marking/divert process I may include different steps depending on how the system 100 is configured. For example, in some embodiments, the error handling procedure can include diverting the failed RFID object to a storage container. In some embodiments, a RFID object may have a mark printed on the object indicating the RFID object is not usable.

The different processes described above are ongoing processes that continue to repeat as long as the encode job is in process.

One or more embodiments of the present invention may comprise a method and an apparatus for focusing RFID signal to a single RFID inlay. Some embodiments may comprise a method and apparatus for focusing the RF energy from a RF system antenna in a manner that the RF field of view can be focused to only one of a plurality of RFID inlays passing by the antenna at a time.

RFID inlays are typically incorporated into labels or cardstock to form tags that can be applied to items or item packaging either directly through the use of adhesive or indirectly such as through a fastener, e.g. string, plastic tie, etc. Due to the high rate of adoption by the apparel retail sector of Ultra High Frequency (UHF) RFID tagging at the item level, all areas of RFID tag manufacturing and encoding are working to increase their production capabilities. While RFID chip makers, RFID tag makers and RFID tag converters are increasing their ability to provide the industry the rapidly increasing quantity of UHF RFID tags to meet the rising demand, very little is being done to increase the rate of encoding and verification of said UHF RFID tags.

A common means of encoding RFID labels and tags (Product) is to move the RFID product past one to many RFID antennas that communicate with the RFID product to identify (singulate) the individual RFID item and then to encode the singulated RFID item. This process of singulation becomes more difficult the smaller the RFID product and the closer the plurality of RFID products are to each other.

A known method of singulating a RFID product is varying the strength of the RF signal being emitted from the RFID antenna. Then, if there is still more than one RFID product identified by the RFID system, the RFID product showing the strongest response will be determined to be the product that is closest to the antenna, or the singulated product. One problem with this method of singulation is that the product closest to the antenna may be weaker than an item farther from the antenna and the product farther from the antenna could be mistakenly recorded as the singulated product. Another known method is using the magnetic coupling model where they start and stop the RF signal. One problem with this method of singulation is that the overhead of starting and stopping reduces throughput. In other words, a concern with conventional RFID encoding and verification systems is that the RF signal emanating from RFID antenna are not focused and therefore may cross couple, or read inlays in front of or behind the target inlay. Accordingly, there is a need to eliminate the bottleneck created by this inefficient singulation process. Accordingly, there is a need for a RF signal focusing apparatus that will restrict the RF signal to a focused beam.

Exemplary embodiments disclosed herein includes an apparatus that will address the concerns listed above. This invention utilizes a new RF focusing antenna enclosure to eliminate unintentional tag reads.

According to at least one exemplary embodiment, a RFID antenna is housed in a metallic RF shielding enclosure. The metallic enclosure has an adjustable opening on one side of the enclosure. A plurality of adjustable shielding methods may be used to allow the size of the opening to be increased or decreased depending on the size of the RFID product being processed.

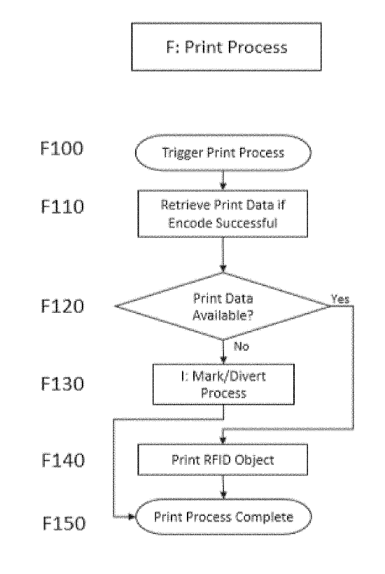

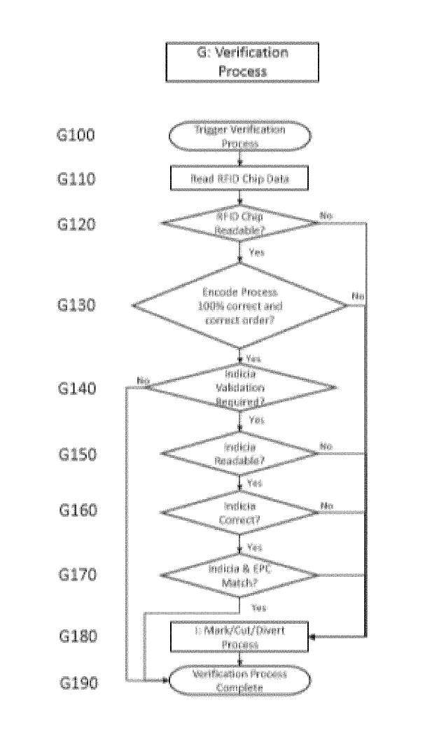

FIG. 5 is a diagram of an exemplary embodiment of an apparatus 100 for focusing RF energy from a RF antenna to a RFID inlay. Apparatus 100 includes a RFID antenna 10 housed in a metallic case, a metallic lid 30 with a hole (aperture) 60 cut in it to let the RF energy pass through, a metallic shielding plate 40 to limit the size of the aperture and shielding place locking screws 50 to fasten the shielding plate in place.

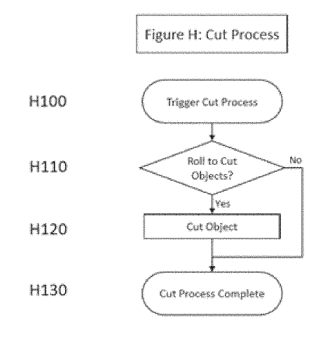

Turning to FIG. 6, an exemplary embodiment of a conventional singulation techniques is shown. The RFID antenna is not shielded and emits a spherical or cone shaped RF energy field 70 that is energizing more than one RFID inlay 80 on a label web or random RFID tag transport mechanism 90. Due to the lack of focus of the RF energy field, it is very difficult to singulate a RFID item.

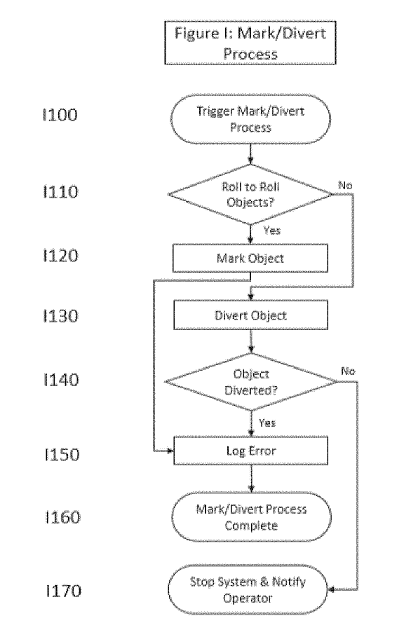

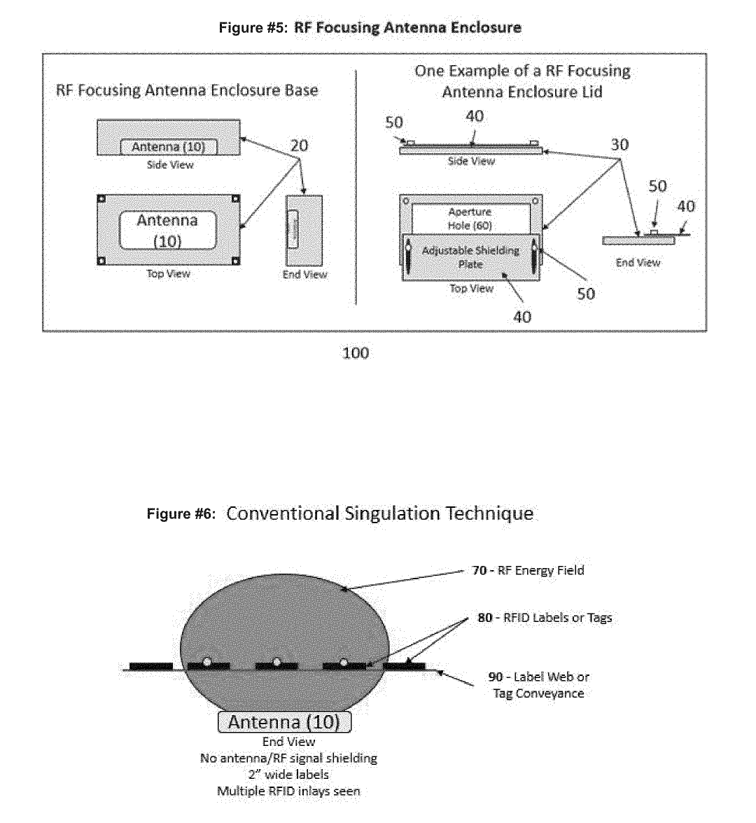

In FIG. 7, an exemplary embodiment of this inventions singulation techniques is shown. The RFID antenna is enclosed in a RF energy focusing apparatus. Due to the shielding, it emits a focused RF energy field 70 that is energizing only the one RFID inlay 80 on a label web or random RFID tag transport mechanism 90 that is directly above the RF energy focusing apparatus.

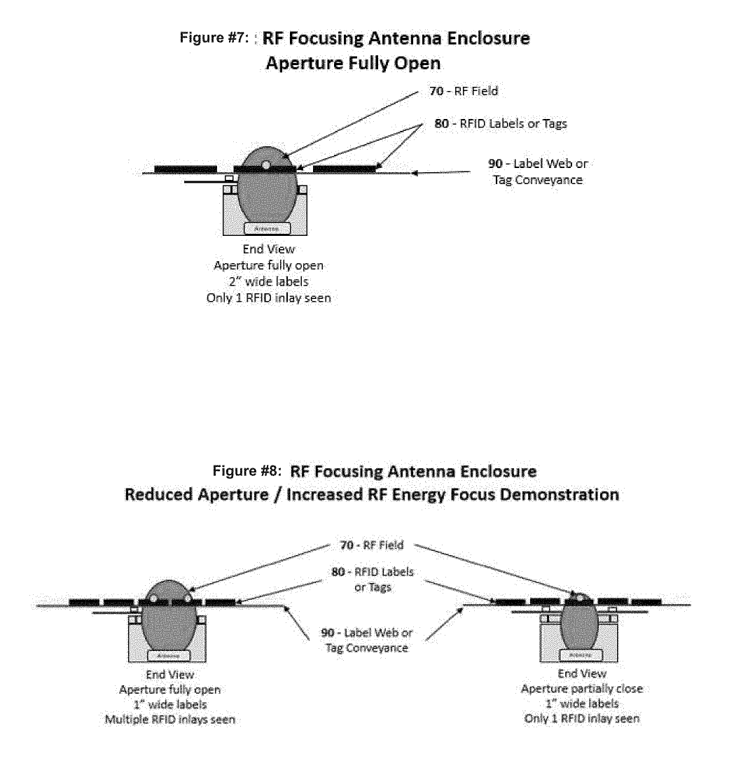

In FIG. 8, an exemplary embodiment of the inventions shielding plate is shown. The RFID antenna is enclosed in a RF energy focusing apparatus but due to the large opening of the RF Focusing Antenna Enclosure Lid 30, and the smaller size of the RFID labels compared to FIG. 3, more than one RFID label is seen. By closing the aperture hole 60 size with the adjustable shielding plate 40 the RF energy field is reduced to only see one RFID label.

The solution to Disadvantage A that our innovation provides is to load share the transponder encoding process across a scalable number of RFID encoders allowing the encoding process to occur over a greater distance that previously performed so the line can move at a greater speed, thus increasing production capabilities. This solution also provides a failsafe encoding feature where if one of the load sharing RFID encoders fails performing its portion of the shared encoding process, the next encoder(s) will perform the failed encoding.

The solution to Disadvantage B that our innovation provides is to measure the strength of each working RFID transponder, compare that measurement to a user-configurable setting and fail RFID transponders that do not meet or exceed said setting.

The solution to Disadvantage C that our innovation provides high-speed digital cameras to capture the printed indicia and then verify the printed indicia matches the encoded RFID transponder.

The solution to Disadvantage D that our innovation provides is to include an inkjet marking device capable of printing information pertaining to the reason for RFID transponder failure.

The solution to Disadvantage E that our innovation provides is to queue each RFID transponder that fails the production process and send that queue for production at the end of the batch run.

The present embodiment provides the following elements:
RFID encoding is load shared across scalable number of encoders so that if the first RFID encoder does not fully encode the RFID transponder, the next down-stream RFID encoder(s) will, providing failsafe encoding of each RFID enabled object
Validate that the RFID chip is encoded to match any printed indicia
Validate RFID transponder strength meets or exceeds user-definable level
Customized marker to mark on failures
Feedback to reprint on fails
High production speed due to load sharing of RFID transponder encoding process and failsafe encoding process
Automatic reprinting capabilities
Able to work with extra-long labels that are longer than the distance between the RFID read and encoding locations
Customizable print capabilities to mark on failed or weak RFID products
Capable of using any printer, not just the one contained in the system
if the process fails to complete the tag write at the first encoder due to poor tag performance or the physical speed at which the tags is moving across the encoder, the next encoder in line will pick up where the last encoder left off and continue to perform the encoding process. This will repeat again for all of the n encoding stations on the system until the tag is completely encoded

The following claims are hereby incorporated into the detailed description, with each claim standing on its own as a separate embodiment.

What is claimed is:

1. A Method for Encoding, Verifying, and Printing of RFID Enabled Objects, comprising the steps of:
pre-printing a plurality of unencoded RFID objects;
coupling each of the plurality of unencoded RFID tags to each of a plurality of objects;
transporting the plurality of RFID objects from location 1 to location 2;
scanning the plurality of RFID objects to capture optional indicia preprinted on the plurality of RFID objects;
scanning the plurality of RFID objects with a continuous non-triggered RF read process of the tag's unique tag identification such as the factory encoded EPC for said RFID objects;
encoding each of the unencoded RFID tags coupled to each of the plurality of like RFID objects.
encode position independent of tag such that order of encoding is not determined, but encodes proper data on expected tag.

2. The method of claim 1, further comprising:
the first location is a plurality of objects containing RFID inlays awaiting processing; and the second location is a collection of a plurality of RFID object that have been encoded, verified and possibly printed upon.

3. The method of claim 2, wherein:
printing the plurality of unencoded RFID tags at a location after the first location; and transferring the plurality of encoded RFID tags to the second location past at least one RFID antenna.

4. The method of claim 1, further comprising:
Optional printing of desired indicia on the plurality of RFID objects either before or after encoding the RFID objects, the indicia corresponding to desired product or manufacturer information, either obtained from the indicia or provided with a data file.

5. The method of claim 1, further comprising:
wherein the unencoded RFID objects are RFID integrated circuit chips adhered to RFID antennas and possibly converted further into labels, tags or other items (RFID Objects).

6. The method of claim 1, further comprising:
A scalable plurality of cascaded RFID encoders enabling failsafe encoding of a plurality of RFID objects Each of the plurality of cascaded RFID encoders will re-energize the RFID transponder prior to encoding

7. The method of claim 1, further comprising:
Each of the plurality of cascaded RFID encoders will contain a multi-spindle means to extend the duration of time each RFID label is within the RFID encoder RF field in order to increase the travel speed of the RFID label web for larger pitch labels to increase encoding throughput.

8. The method of claim 1, further comprising:
A system that is user configurable to encode all GS1 encoding schemes as well as proprietary multi-chip serialization techniques and proprietary scan scan encoding schemes.

9. The method of claim 1, further comprising:
Testing encoded RFID objects between location 1 and location 2 so as to determine that all RFID objects are encoded with correct information.
Testing encoded RFID objects between location 1 and location 2 so as to determine that all RFID objects are encoded to match option indicia when required.

10. The method of claim 1, further comprising:
During the verification process the encoded EPC and the factory TID will be captured and stored for anti-counterfeiting authentication purposes.

11. The method of claim 1, further comprising:
Optional cutting of encoded RFID objects between location 1 and location 2 so as to convert roll based RFID objects to cut single RFID objects.

12. The method of claim 1, further comprising:
sorting the products such that only like products passing verification of correct encoding of said RFID object and correct optional printing of said RFID object is correct and complete.

13. The method of claim 1, further comprising:
testing encoded RFID tags between location 1 and location 2 so as to determine that all RFID objects respond with a RSSI equal to or stronger than strength set in configuration settings.

14. The system of claim 1, further comprising:
a marking mechanism for marking RFID objects that do not meet the verification requirement such that each of the plurality of failed objects is marked with a distinguishable mark indicating the RFID object has not passed verification.
a sorting mechanism for sorting RFID objects that do not meet the verification requirement such that each of the plurality of failed cut single objects is sorted into a container that contains like objects.
Production data for RFID objects that do not meet the verification requirement will automatically be place in the queue for reprocessing.

15. A System for Encoding, Verifying, and Printing RFID Enabled Objects, comprising:
means for pre-printing a plurality of unencoded RFID objects;
means for a coupling of each of a plurality of unencoded RFID tags to each of the plurality of RFID objects;
means for a transporting of the plurality of RFID objects from a first location to a second location;
means for a scanning of the plurality of RFID objects to capture optional indicia preprinted on the plurality of RFID objects;
means for a scanning of the plurality of RFID objects with a continuous non-triggered RF read process of the RFID objects; and
means for an encoding of each of the unencoded RFID tags coupled to each of the plurality of like RFID objects.
